(19) United States
(12) Patent Application Publication
(10) Pub. No.: US 2024/0427590 A1
(43) Pub. Date: Dec. 26, 2024

(54) UPDATING AN OPERATING SYSTEM, CONFIGURING A DEVICE FOR AN OPERATING SYSTEM UPDATE, AND ASSOCIATED UNITS, SYSTEMS, DEVICES, METHODS, AND COMPUTER-READABLE MEDIA

(71) Applicant: LiveView Technologies, LLC, Orem, UT (US)

(72) Inventor: Michael Nelson Abbott, Orem, UT (US)

(21) Appl. No.: 18/495,517

(22) Filed: Oct. 26, 2023

Related U.S. Application Data
(60) Provisional application No. 63/509,610, filed on Jun. 22, 2023.

(51) Int. Cl. G06F 8/65; G06F 8/61

(52) U.S. Cl. CPC G06F 8/65; G06F 8/63

(57) ABSTRACT

Various embodiments relate to updating an operating system of a device. In some embodiments, a bootloader may be installed on the device. Further, during reboot, the device may check for any operating system updates. Further, if necessary, an updated version of an operating system, to be installed, may be provided to and installed on the device. Associated systems, methods, units, and computer-readable media are also disclosed.

### PRIORITY CLAIM

This application claims the benefit of the filing date of U.S. Provisional Patent Application Ser. No. 63/509,610 filed Jun. 22, 2023, for “Operating System Update, and Associated Systems, Methods, Units, and Computer-Readable Media,” the disclosure of which is hereby incorporated herein in its entirety by this reference.

### TECHNICAL FIELD

This disclosure relates generally to updating an operating system. More specifically, this disclosure relates to updating a number of operating systems, configuring a number of devices for an operating system update, and to related units, systems, devices, methods, and computer-readable media.

### BACKGROUND

An operating system (OS) is system software that manages computer hardware and software resources and provides services for computer programs. Computer programs, excluding firmware, may require an operating system to function. To ensure the security and reliability of devices, enterprises can update their devices with newer versions of operating systems. However, providing timely and effective operating system updates can be costly in time and effort, especially in an environment that includes multiple devices.

### BRIEF DESCRIPTION OF THE DRAWINGS

FIG. 1 depicts an example system, in accordance with one or more embodiments of the disclosure.

FIG. 2A depicts a partition diagram of an example hard drive of a device.

FIG. 2B depicts a partition diagram of another example hard drive of a device.

FIG. 3 is a simplified diagram of an example system, according to various embodiments of the disclosure.

FIG. 4 depicts a hard drive prior to and after installation of a bootloader and an updated operating system, in accordance with various embodiments of the disclosure.

FIG. 5 depicts an example flow for configuring a device, in accordance with various embodiments of the disclosure.

FIG. 6A depicts a partition diagram of an example hard drive of a device, according to various embodiments of the disclosure.

FIG. 6B depicts a partition diagram of another example hard drive of a device, according to various embodiments of the disclosure.

FIG. 7 depicts an example process, in accordance with various embodiments of the disclosure.

FIG. 8 is a flowchart of an example method of updating an operating system, according to various embodiments of the disclosure.

FIG. 9 depicts another example system including a mobile unit, in accordance with various embodiments of the disclosure.

FIG. 10 depicts an example system including a mobile unit, a server, and one or more devices, in accordance with various embodiments of the disclosure.

FIG. 11 illustrates another example system, according to one or more embodiments of the disclosure.

### DETAILED DESCRIPTION

Referring in general to the accompanying drawings, various embodiments of the disclosure are illustrated to show example embodiments related to updating an operating system of a device. It should be understood that the drawings presented are not meant to be illustrative of actual views of any particular portion of an actual circuit, device, system, or structure, but are merely representations which are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Various embodiments of the disclosure relate to updating an operating system of a device (e.g., an operating system of a controller of the device). In some embodiments, a number of portions of an operating system may be conveyed (e.g., sequentially, one at a time) (e.g., via a cellular connection) to the device (e.g., from a cloud service or other device) and thereafter installed on the device. Further, various embodiments disclosed herein relate to configuring (e.g., retroactively configuring) the device (e.g., a controller of the device) such that an operating system (e.g., an updated version of an operating system) may be installed on the device. More specifically, some embodiments relate to installing a bootloader on a device (e.g., a device that was previously deployed), such that an operating system of the device may be updated.

As will be appreciated, various embodiments disclosed herein may enable an operating system of a device (e.g., a remote, mobile unit) to be updated, without requiring personnel (e.g., a technician) to physically travel to the device, thus substantially saving time and resources. Further, various embodiments disclosed herein may enable a bootloader to be installed on a device (e.g., a device that was previously deployed) (i.e., without requiring personnel to physically travel to the device), thus enabling the operating system of the device to be updated. For at least these reasons, various embodiments of the disclosure, as described more fully herein, provide a technical solution to one or more problems that arise from technology that could not reasonably be performed by a person, and various embodiments disclosed herein are rooted in computer technology in order to overcome the problems and/or challenges described above. Further, at least some embodiments disclosed herein may improve computer-related technology by allowing computer performance of a function not previously performed by a computer.

Although various embodiments are described herein with reference to security and/or surveillance systems and/or mobile security and/or mobile surveillance units, the present disclosure is not so limited, and the embodiments may be generally applicable to any system and/or device that may or may not include security and/or surveillance systems and/or units. Further, although some embodiments are disclosed with reference to a mobile unit, the disclosure is not so limited, and a person having ordinary skill will understand that various embodiments may be applicable to stationary units (e.g., stationary security/surveillance devices), such as a unit coupled to a stationary pole (e.g., a light pole), a structure (e.g., of a business or a residence), a tree, etc. Embodiments of the disclosure will now be explained with reference to the accompanying drawings.

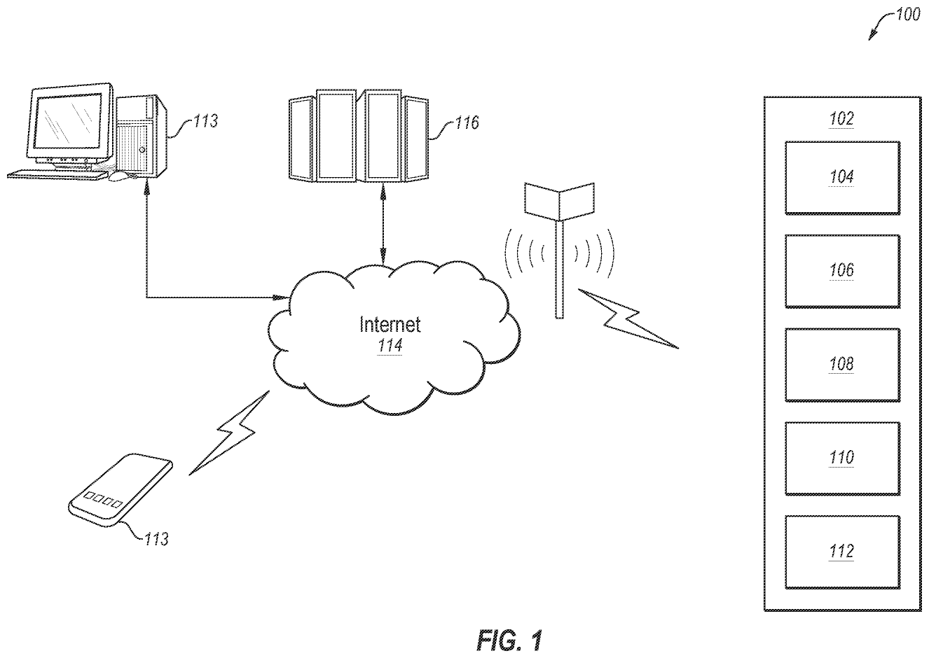

FIG. 1 illustrates a system 100, according to one or more embodiments of the disclosure. System 100, which may include a security and/or surveillance system, includes a unit 102, which may also be referred to herein as a “mobile unit,” a “mobile security unit,” a “mobile surveillance unit,” a “physical unit,” or some variation thereof. According to various embodiments, unit 102 may include one or more sensors 104 (e.g., cameras, weather sensors, motion sensors, noise sensors, chemical sensors, without limitation) and one or more output devices 106 (e.g., lights, speakers, electronic displays, without limitation). For example only, sensors 104 may include one or more cameras, such as thermal cameras, infrared cameras, optical cameras, PTZ cameras, bi-spectrum cameras, any other camera, or any combination thereof. Further, for example only, output devices 106 may include one or more lights (e.g., flood lights, strobe lights (e.g., LED strobe lights), and/or other lights), one or more speakers (e.g., two-way public address (PA) speaker systems), any other suitable output device (e.g., a digital display), or any combination thereof.

In some embodiments, unit 102 may also include one or more storage devices 108. Storage device 108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 104. In some embodiments, during operation, storage device 108 may continuously record data (e.g., video, images, i-frames, and/or other data) captured by one or more sensors 104 (e.g., cameras, lidar, radar, RF sensors, environmental sensors, acoustic sensors, without limitation) of unit 102 (e.g., 24 hours a day, 7 days a week, or any other time scenario).

Unit 102 may further include a computer 110, which may include memory and/or any suitable processor, controller, logic, and/or other processor-based device known in the art. Computer 110 may include an operating system (e.g., installed on a hard drive), as will be described more fully below. Moreover, although not shown in FIG. 1, unit 102 may include one or more additional devices including, but not limited to, one or more microphones, one or more solar panels, one or more generators (e.g., fuel cell generators), or any combination thereof. Unit 102 may also include a communication device 112, which may comprise any suitable and known communication device (e.g., a modem (e.g., a cellular modem, a satellite modem, a Wi-Fi modem, etc.)). In some embodiments, communication device 112 may include one or more radios and/or one or more antennas. As will be appreciated, components of unit 102 may be suitably coupled via wired connections, wireless connections, or a combination thereof.

System 100 may further include one or more electronic devices 113, which may comprise, for example only, a mobile device (e.g., mobile phone, tablet, etc.), a laptop computer, a desktop computer, or any other suitable electronic device including a display. Electronic device 113 may be accessible to one or more end-users. Additionally, system 100 may include a server 116 (e.g., a cloud server), which may be remote from unit 102. Communication device 112, electronic devices 113, and server 116 may be coupled to one another via the Internet 114 (e.g., via a cellular connection).

According to various embodiments of the disclosure, unit 102 may be within a first location (a “camera location” or a “unit location”), and server 116 may be within a second location, remote from the first location. In addition, each electronic device 113 may or may not be remote from unit 102 and/or server 116. As will be appreciated by a person having ordinary skill in the art, system 100 may be modular, expandable, and/or scalable.

As noted above, in some embodiments, unit 102 may include a mobile unit (e.g., a mobile security/surveillance unit). In these and other embodiments, unit 102 may include a portable trailer (not shown in FIG. 1), a storage box (e.g., including one or more batteries) (not shown in FIG. 1), and a mast (not shown in FIG. 1) coupled to a head unit (e.g., including, for example, one or more cameras, one or more lights, one or more speakers, and/or one or more microphones) (not shown in FIG. 1). According to various examples, in addition to sensors and output devices, a head unit of unit 102 may include and/or be coupled to storage device 108, computer 110, and/or communication device 112.

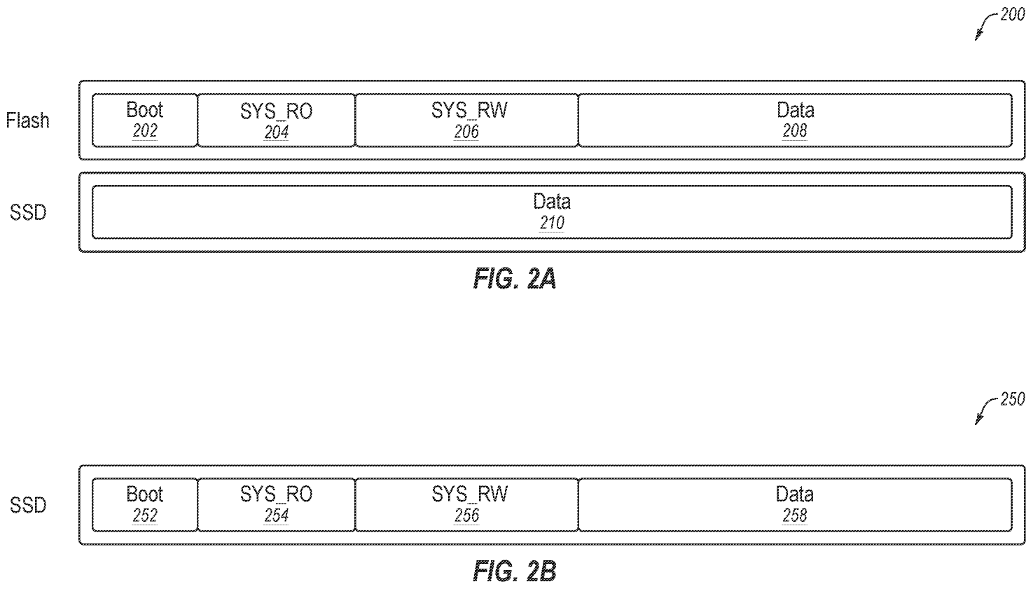

FIG. 2A depicts a partition diagram of an example hard drive 200 including a flash drive, which includes a boot information partition 202, a system read only (SYS_RO) partition 204, system read write (SYS_RW) partition 206, and a data partition 208 (e.g., for storing data). Hard drive 200 further includes a solid-state drive (SSD) including a data partition 210 (i.e., for storing data). FIG. 2B depicts another partition diagram of another example hard drive 250 including an SSD, which includes a boot information partition 252, a system read only (SYS_RO) partition 254, a system read write (SYS_RW) partition 256, and a data partition 258 (e.g., for storing video recordings and other data). The partitions shown in FIGS. 2A and 2B depict hard drives prior to installation of a bootloader, as described more fully below. It is noted that the example hard drives illustrated in FIGS. 2A and 2B may include hard drives prior to performing various embodiments of the disclosure (e.g., prior to installation of a bootloader and an updated operating system).

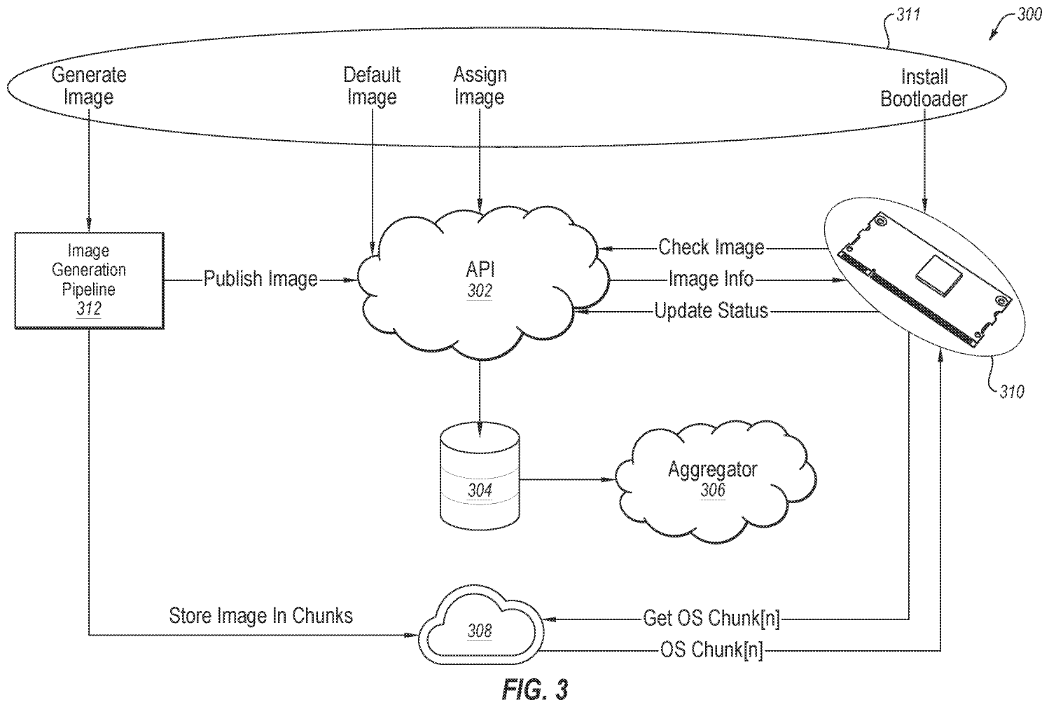

FIG. 3 is a simplified diagram of a system 300, according to various embodiments of the disclosure. System 300 includes an application programming interface (API) (e.g., an operating system manager API) 302, a database (e.g., a message store) 304, an aggregator (e.g., an edge operating system aggregator) 306, a cloud service 308, and a device 310. System 300 may also include source 311, which may include one or more sources of, for example, images (e.g., operating system images), programs (e.g., a bootloader), and/or other files. In some embodiments, API 302, database 304, aggregator 306, and/or cloud service 308 may be part of the cloud (e.g., including one or more cloud servers).

For example, device 310 may be part of computer 110 (e.g., a controller, which is also referred to herein as an “edge controller”) of FIG. 1, which may be part of a unit (e.g., a mobile unit). Although system 300 is depicted as including only one device 310, system 300 may include any number (e.g., a plurality (e.g., 10, 100, 1000, 10,000, 100,000, etc.)) of devices 310. More specifically, in some examples, system 300 may be associated with and/or include a number of units (e.g., mobile surveillance units), wherein each unit includes at least one device 310.

In some embodiments, one or more operating system images may be generated and conveyed (e.g., via source 311 and/or an image generation pipeline 312 (e.g., a tool by the Raspberry Pi Foundation or the like)) to cloud service 308. Further, the generated operating system image may be provided (e.g., via image generation pipeline 312 and API 302) to and stored in database 304.

According to various embodiments, the cloud (e.g., including database 304) may include information regarding each device (e.g., of a plurality of devices, such as controllers of a plurality of mobile units), such as what operating system is currently installed on each device (i.e., which devices are running which operating systems), which versions of the operating systems are installed on each device, and/or what version of what operating system should be installed on each device (e.g., based on available updates and/or other information). For example, upon release of a new version of an operating system, database 304 may be updated (e.g., via source 311) to identify that the new version of the operating system should be installed on one or more devices.

Aggregator 306 may be configured to retrieve and/or receive data from a database (e.g., a general purpose database) used by various (e.g., many) applications, and present data concerning OS updates in an isolated format (e.g., what OS is assigned to what device). Aggregator 306 may produce a database, which may be consumed by, for example, a server (e.g., cloud server) that provides the API (e.g., so that data is readily available).

Also, in some embodiments, a default image for each device a number of devices may be identified and/or provided (e.g., via source 311) to database 304. For example, an operating system image provided to cloud service 308, or any other image, may be identified as the default image for device 310. Further, information regarding (e.g., identifying) what operating system should be assigned to device 310 may be provided (e.g., via source 311) to database 304. Moreover, as described more fully herein, a bootloader may be provided (e.g., via source 311) and installed on device 310.

According to some embodiments, generating and supplying an operating system image, identifying a default operating system image, assigning an operating system image, and installing the bootloader may be manual or automated processes, and any files, programs, or other associated information may be provided from any source (e.g., source 311 or another source), such as another system or device (e.g., operated by an administrator or user).

According to various embodiments, after a bootloader is installed on device 310 and during operation of system 300, device 310 may (e.g., upon boot) inform API 302 of its current operating system version and query API 302 whether it (i.e., device 310) includes the desired operating system or whether device 310 should update its operating system. API 302 may ascertain this or other information via, for example, database 304.

If it is determined that device 310 includes the correct (e.g., most recent) operating system version, device 310 may reboot. If it is determined that device 310 does not include the correct (e.g., most recent) operating system, API 302 may identify (e.g., via accessing database 304) the correct operating system (i.e., that should be installed) and inform device 310 how and/or where to access the correct operating system image. Further, assuming device 310 desires to update its operating system (e.g., based on information from API 302), device 310 may request and/or retrieve the appropriate operating system image from cloud service 308.

In some embodiments, the operating system image may be requested (e.g., by device 310) and delivered or retrieved (e.g., from cloud service 308 to device 310 (e.g., via cellular communication)) in a number (e.g., a plurality) of chucks (also referred to herein as “portions”) (e.g., sequentially, one chunk at a time). For example, each chunk of the operating system image may be downloaded individually (e.g., sequentially, one at a time) into memory (e.g., random access memory (RAM)) (i.e., of device 310) and then unpacked into a new file system (e.g., of device 310).

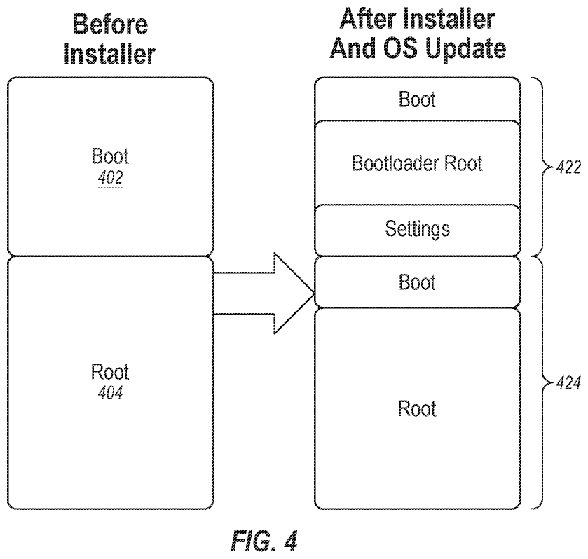

FIG. 4 depicts a hard drive before installation (e.g., of an updated bootloader) and the hard drive after installation of the bootloader and the updated OS. As depicted, before installation, the hard drive includes a boot partition 402 and a root partition 404. After the installation of the bootloader and the updated OS, the hard drive includes a bootloader portion 422 and an operating system portion 424. Bootloader portion 422 includes a boot partition, a bootloader root partition, and a settings partition, and operating system portion 424 includes boot partition and a root partition.

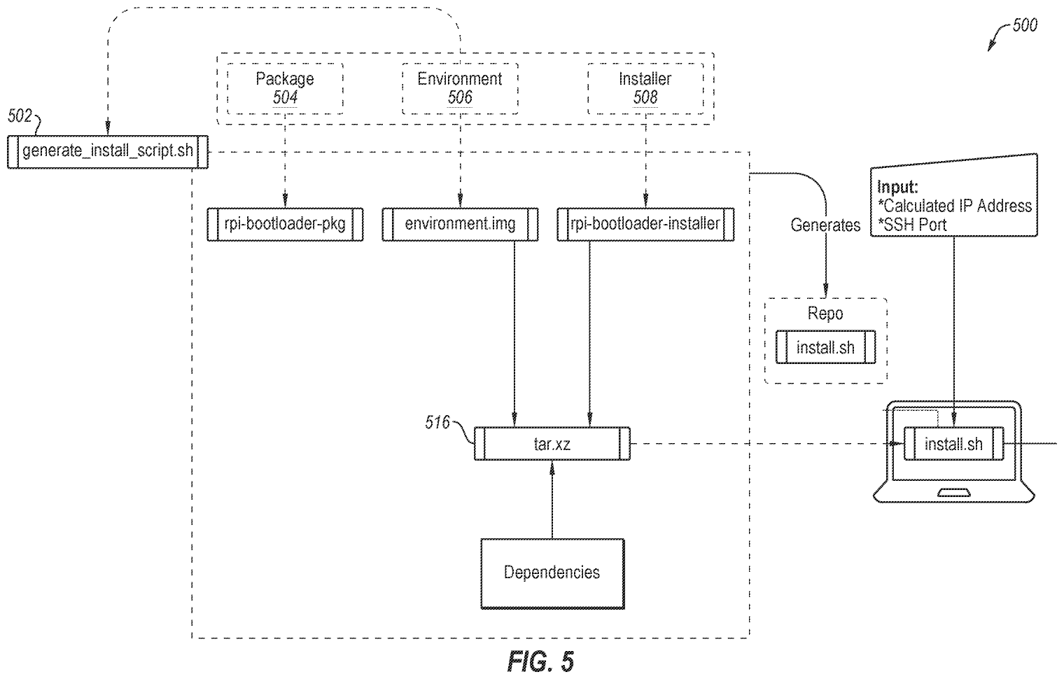

FIG. 5 depicts an example flow 500 for configuring a device, in accordance with various embodiments of the disclosure. More specifically, flow 500 may include or represent a process for installing a bootloader on a controller (e.g., a hard drive of the controller) (e.g., of a unit, such as a mobile unit). After bootloader installation, at each reboot, the controller may check for new operating system updates.

Flow 500 may include generating (i.e., at block 502) an install script (e.g., “install.sh” shown in FIG. 5) that bundles a package repository 504, an environment repository 506, and/or an installer repository 508 (e.g., into one or more files). In some examples, these repositories may be bundled into one or more files that may be provided to, for example, support personnel (e.g., tech support) for installing a bootloader.

Package repository 504 (e.g., “rpi-bootloader-pkg” as shown in FIG. 5) may include a program that updates an operating system (also referred to herein as an “operating system updater program,” an “operating system updater,” or some variation thereof). Environment repository 506 may include an operating system that an operating system updater program runs on, and when an image file is built, the image file includes package repository 504. Installer repository 508 may include a program that writes an environment image (“environment.img” as shown in FIG. 5) to disk during a process of deploying an operating system updater to a device (e.g., of a mobile device) that may not have previously had an operating system updater.

A file (e.g., “tar.xy” as shown in FIG. 5) 516, which may include an encoded file (e.g., a base64 encoded file), may be appended to an install script template. For example, an IP address and a port (e.g., SSH port) for a device (i.e., including the controller) to be updated may be provided (e.g., by an administrator, such as tech support), and upon execution of the script (e.g., install.sh), file 516 may be copied to the device and unpacked. In some embodiments, the script (e.g., install.sh) may copy file 516 to the device (e.g., the controller), unpack file 516 (e.g., to flash memory), and reboot the controller, which may execute the program (e.g., rpi-bootloader-installer) of installer repository 508.

In some embodiments, a script (e.g., install.sh) may copy file 516 to a device (e.g., the controller), unpack the contents of file 516 (e.g., to memory, such as flash memory), verify the integrity of the data, and execute the installer (e.g., rpi-bootloader-installer) of installer repository 508. This installer then replaces the existing operating system with the environment which performs the operating system update (“environment.img” as shown in FIG. 5). Subsequently, the controller may be rebooted, at which point the operating system updater may be executed.

Modifications, additions, or omissions may be made to flow 500 without departing from the scope of the present disclosure. For example, flow 500 may be implemented in differing order and/or with different components (e.g., files). Furthermore, the outlined operations, actions, and components are only provided as examples, and some of the operations, actions, and/or components may be optional, combined into fewer operations, actions, and/or components, or expanded into additional operations, actions, and/or components without detracting from the essence of the disclosed embodiment.

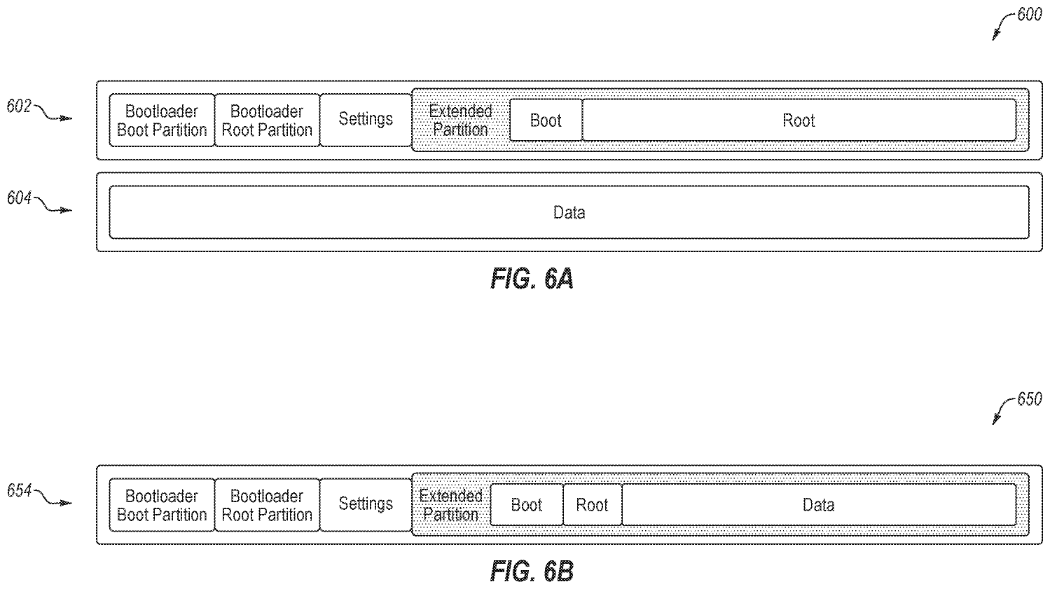

FIG. 6A depicts a partition diagram of an example hard drive 600, according to various embodiments of the disclosure. More specifically, FIG. 6A depicts an example hard drive after a retroactive update (e.g., bootloader install and operating system update) of hard drive 200 of FIG. 2A. Hard drive 600 includes a flash drive 602 and an SSD 604. Flash drive 602 includes a bootloader boot partition, a bootloader root partition, a settings partition, and an extended partition including a boot partition and a root partition. SSD 604 includes a data partition (e.g., for storing data, such as image and/or video data).

FIG. 6B depicts a partition diagram of another example hard drive 650, according to various embodiments of the disclosure. More specifically, FIG. 6B depicts another example hard drive after a retroactive update (e.g., bootloader install and operating system update) of hard drive 250 of FIG. 2B. Hard drive 650 includes an SSD 654, which includes a bootloader boot partition, a bootloader root partition, a settings partition, and an extended partition including a boot partition, a root partition, and a data partition (e.g., for storing data, such as image and/or video data).

In some embodiments (e.g., updating hard drive 250 to hard drive 650), a location of data (e.g., customer data including, for example, image and/or video data) may be determined (e.g., prior to any bootloader installation or operating system update) such that this data may be preserved (e.g., not erased or overwritten) during installation of the bootloader and/or installing an updated operating system.

As will be appreciated, various embodiments are related to retroactively (e.g., automatically and/or remotely) updating units (e.g., mobile units) that may have already been deployed (e.g., in the field). More specifically, for example, a hard drive (e.g., of a controller) of a mobile unit that has already been deployed (e.g., in use in the field (e.g., at a remote location)) may be updated such that an operating system (e.g., installed on the hard drive) may be remotely, and possibly automatically, updated. More specifically, for example, a mobile unit, which is deployed in the field (e.g., in a remote location), may include a controller with hard drive 200 of FIG. 2A. Further, in this example, a bootloader may be installed (e.g., remotely), and an operating system may be updated (e.g., remotely), such that the controller of the mobile unit includes hard drive 600 of FIG. 6A. In another example, a mobile unit, which is deployed in the field (e.g., in a remote location), may include a controller with hard drive 250 of FIG. 2B. Further, in this example, a bootloader may be installed (e.g., remotely), and an operating system may be updated (e.g., remotely), such that the controller of the mobile unit includes hard drive 650 of FIG. 6B.

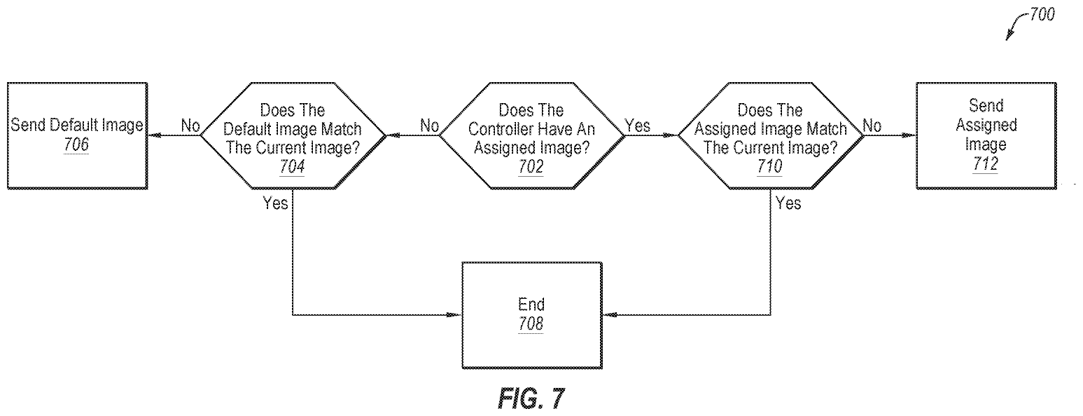

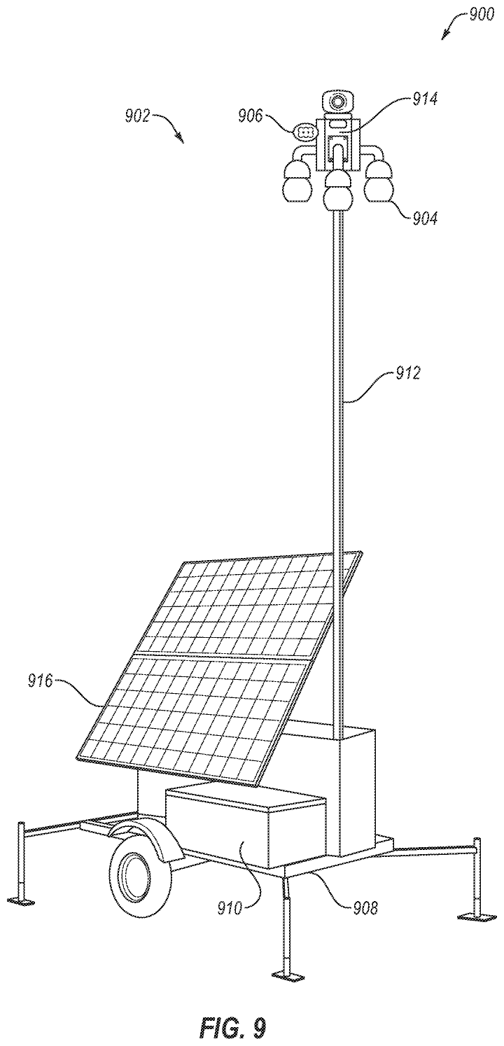

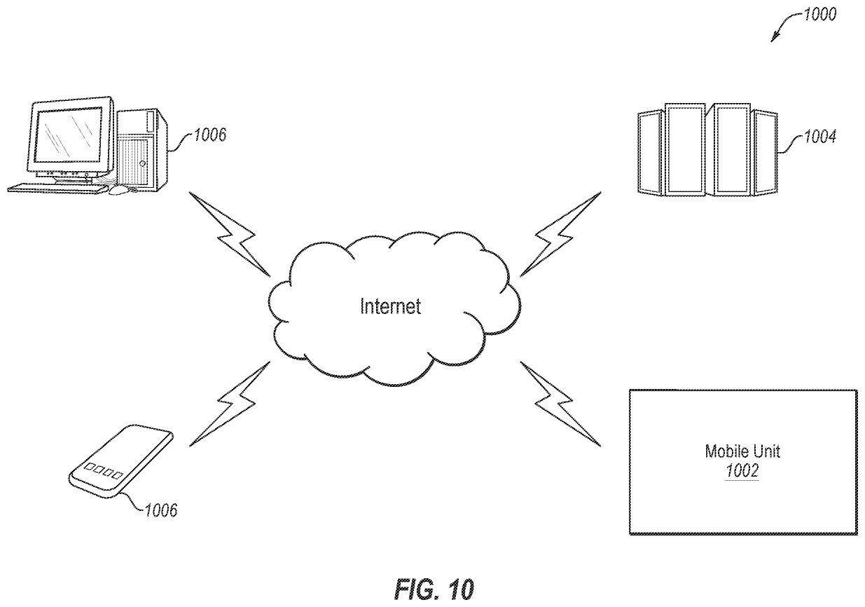

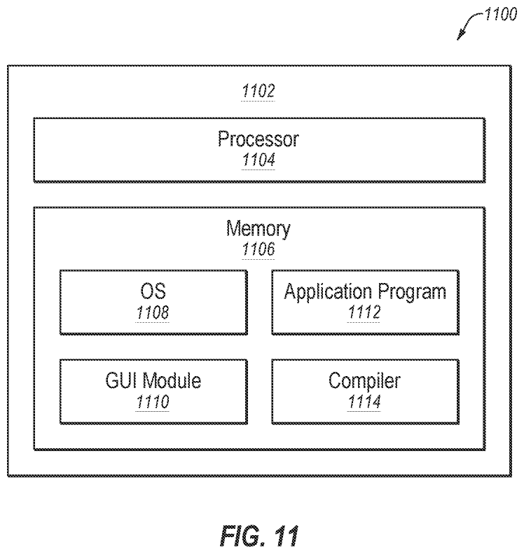

FIG. 7 depicts a method 700, according to various embodiments of the disclosure. For example, method 700 may be related to determining whether a device (e.g., a controller, such as device 310 of FIG. 3) should update its operating system, and depending on a scenario, sending (i.e., to the device) or retrieving (e.g., from a cloud service) either a default operating system image or an assigned operating system image, in accordance with various embodiments of the disclosure. Method 700 may be arranged in accordance with at least one embodiment described in the disclosure. Method 700 may be performed, in some embodiments, by a device, system, or flow, such as system 100 (see FIG. 1), system 300 (see FIG. 3), flow 500 (see FIG. 5), system 900 (see FIG. 9), system 1000 (see FIG. 10), system 1100 (see FIG. 11), or another device, system, or flow. Although illustrated as discrete blocks, various blocks may be divided into additional blocks, combined into fewer blocks, or eliminated, depending on the desired implementation.

At block 702, it is determined whether the device (e.g., a controller of a mobile unit) has an assigned operating system image. If the device does not have an assigned operating system image, method 700 proceeds to block 704, wherein it is determined whether a default operating system image of the device matches a current operating system image of the device. For example, the device may include a controller (e.g., device 310 of FIG. 3).

If the default operating system image does match the current operating system image of the device, method 700 proceeds to block 706, wherein the default operating system image may be provided to (or retrieved by) the device (e.g., via a cloud service, such as cloud service 308 of FIG. 3). If the default operating system image does match the current operating system image of the device, method 700 proceeds to block 708.

For example, an API (e.g., API 302 of FIG. 3) may determine whether the device has an assigned image (e.g., via database 304). Further, the API may receive information (e.g., from the device) regarding a current operating system image of the device and determine whether the default operating system image for the device matches the current operating system image of the device.

If the device does have an assigned operating system image, method 700 proceeds from block 702 to block 710, where it may be determined whether the assigned operating system image of the device matches a current operating system image of the device. If the assigned operating system image does not match the current operating system image of the device, method 700 proceeds to block 712, wherein the assigned operating system image may be provided to the device (e.g., from a cloud service) or retrieved (e.g., from a cloud service) by the device. If the assigned operating system image does match the current operating system image of the device, method 700 proceeds to block 708. For example, the API (e.g., API 302 of FIG. 3) may determine whether the assigned operating system image for the device matches the current operating system image of the device.

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

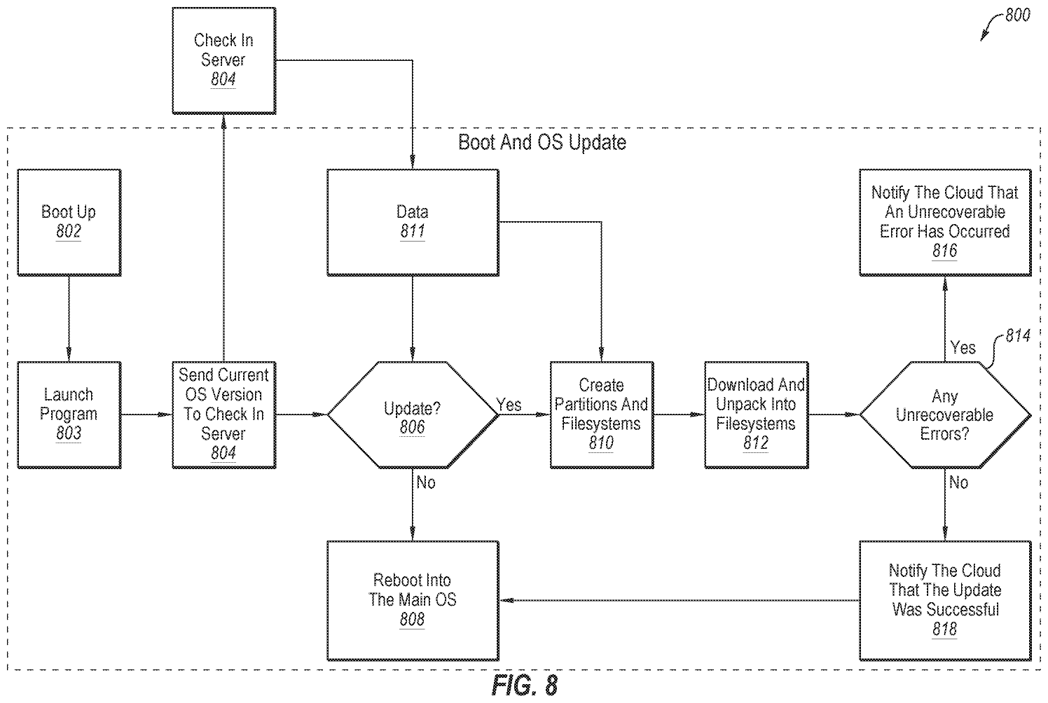

FIG. 8 is a flowchart of an example method 800 of updating an operating system, in accordance with various embodiments of the disclosure. In some examples, method 800 may occur at each boot of an operating system. Method 800 may be arranged in accordance with at least one embodiment described in the disclosure. Method 800 may be performed, in some embodiments, by a device, system, or flow, such as system 100 (see FIG. 1), system 300 (see FIG. 3), flow 500 (see FIG. 5, system 900 (see FIG. 9), system 1000 (see FIG. 10), system 1100 (see FIG. 11), or another device, system, or flow. Although illustrated as discrete blocks, various blocks may be divided into additional blocks, combined into fewer blocks, or eliminated, depending on the desired implementation.

Method 800 may begin at block 802, wherein an operating system of a device (e.g., device 310 of FIG. 3) is booted (“boot up”), and method 800 may proceed to block 803. For example, an operating system of a controller of a unit (e.g., a mobile unit) may boot up. At block 803, a program (e.g., “rpi-bootloader-pkg” as shown in FIG. 5) for updating an operating system may be launched, and method 800 may proceed to block 804.

At block 804, an identifier, which identifies a current version of an operating system of the device, may be conveyed from the device to a server, and method 800 may proceed to block 806. For example, device 310 (see FIG. 3) may convey to an API (e.g., API 302 of FIG. 3) information regarding its current operation system (e.g., what operating system and what version is being run on device 310).

At block 806, it may be determined, based on the identifier, whether the operating system of the device should be updated. For example, the API (e.g., API 302) may access information (e.g., within database 304) to determine which version of which operating system the device should include. If it is determined that the operating system of the device should not be updated, method 800 may proceed to block 808, where the device may be booted via the installed operating system. If it is determined that the operating system of the device should be updated, method 800 may proceed to block 810.

At block 810, partitions and file systems may be created, and method 800 may proceed to block 812. For example, partitions and file systems may be created as outlined in data 811 (e.g., a document, such as a JSON document), which may be provided to the device from the server (e.g., via the API).

At block 812, portions of an updated operating system may be downloaded, and method 800 may proceed to block 814. For example, a number of portions (e.g., a plurality of chunks) of an updated operating system may be downloaded (e.g., via a cellular communication network) individually (e.g., from the cloud (e.g., cloud service 308) (e.g., sequentially, one at a time) into, for example only, random access memory (RAM) of the device). Further, each portion (also referred to herein as a “chunk”) may be decompressed and, after verifying correctness, may be unpacked onto a hard drive of the device. For example, each portion, as identified by data 811 (e.g., received from the server), may be downloaded (e.g., from cloud service 308) one at a time and unpacked into a new file system. According to one example, each portion may be or may comprise a compressed tarball chunk. For example, a hash of each portion may be verified, and a portion may be redownloaded if an error has occurred.

At block 814, it may be determined whether any errors, and more specifically, any unrecoverable errors, were encountered. If one or more errors (e.g., unrecoverable errors) were encountered, method 800 may proceed to block 816, where a notification (e.g., that an error occurred) may be provided (e.g., to the server). If one or more errors were not encountered, method 800 may proceed to block 818, where a notification (e.g., that the update was successful) may be provided (e.g., to the server), and method 800 may proceed to block 808, where the device may be booted via the installed operating system.

Modifications, additions, or omissions may be made to method 800 without departing from the scope of the present disclosure. For example, the operations of method 800 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 9 depicts another example system 900 including a unit 902, in accordance with various embodiments of the disclosure. Unit 902, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 902 may include one or more sensors 904 (e.g., cameras, weather sensors, motion sensors, noise sensors, without limitation) and one or more output devices 906 (e.g., lights, speakers, electronic displays, without limitation). Unit 902 may also include at least one storage device (e.g., internal flash media, a network attached storage device, or any other suitable electronic storage device), which may be configured for receiving and storing data (e.g., video, images, audio, without limitation) captured by one or more sensors of unit 1002. According to some embodiments, unit 902 may include unit 102 of FIG. 1 and/or unit 1002 of FIG. 10.

In some embodiments, unit 902 may include a mobile unit. In these and other embodiments, unit 902 may include a portable trailer 908, a storage box 910, and a mast 912 coupled to a head unit (also referred to herein as a “live unit,” an “edge device,” or simply an “edge”) 914, which may include (or be coupled to) for example, one or more batteries, one or more cameras, one or more lights, one or more speakers, one or more microphones, and/or other input and/or output devices. According to some embodiments, a first end of mast 912 may be proximate storage box 910 and a second, opposite end of mast 912 may be proximate, and possibly adjacent, head unit 914. More specifically, in some embodiments, head unit 914 may be coupled to mast 912 an end opposite an end of mast 912 proximate storage box 910.

In some examples, unit 902 may include one or more primary batteries (e.g., within storage box 910) and one or more secondary batteries (e.g., within head unit 914). In these embodiments, a primary battery positioned in storage box 910 may be coupled to a load and/or a secondary battery positioned within head unit 914 via, for example, a cord reel.

In some embodiments, unit 902 may also include one or more solar panels 916, which may provide power to one or more batteries of unit 902. More specifically, according to some embodiments, one or more solar panels 916 may provide power to a primary battery within storage box 910. Although not illustrated in FIG. 9, unit 902 may include one or more other power sources, such as one or more generators (e.g., fuel cell generators) (e.g., in addition to or instead of solar panels). As will be appreciated, unit 902 may include one or controllers (e.g., within head unit 914) including one or more operating systems, which may be configured and/or updated in accordance with various embodiments disclosed herein.

FIG. 10 depicts a system 1000, in accordance with various embodiments of the disclosure. System 1000 includes a mobile unit 1002, a server 1004, and one or more devices 1006. In one non-limiting example, mobile unit 1002 includes mobile unit 902 (see FIG. 9), server 1004 may include a cloud server or any other server, and device(s) 1006 may include an electronic device, such as a front-end device (e.g., a user device (e.g., mobile phone, tablet, etc.), a desktop computer, or any other suitable electronic device (e.g., including a display)). According to various embodiments, each of server 1004 and device(s) 1006 may be remote from mobile unit 1002. Further, for example, server 1004 may include a cloud-based processor.

According to various embodiments of the disclosure, mobile unit 1002, which may include a modem, may be within a first location (a “camera location” or a “remote location”), and server 1004 may be within a second location, remote from the camera location. In addition, in at least some examples, electronic device 1006 may be remote from the camera location and/or server 1004. As will be appreciated by a person having ordinary skill in the art, system 1000 may be modular, expandable, and/or scalable.

FIG. 11 illustrates a system 1100 that may be used to implement embodiments of the disclosure. System 1100 may include a computer 1102 that comprises a processor 1104 and memory 1106. For example only, and not by way of limitation, computer 1102 may include a workstation, a laptop, or a hand-held device such as a cell phone or a personal digital assistant (PDA), a server (e.g., server 116), computer 110 (see FIG. 1), or any other processor-based device known in the art. In one embodiment, computer 1102 may be operably coupled to a display (not shown in FIG. 11), which presents images to the user via a GUI. As will be appreciated, computer 1102 may include one or controllers including one or more operating systems, which may be configured and/or updated in accordance with various embodiments disclosed herein.

Generally, computer 1102 may operate under control of an operating system 1108 stored in memory 1106, and interface with a user to accept inputs and commands and to present outputs through a GUI module 1110. Although GUI module 1110 is depicted as a separate module, the instructions performing the GUI functions may be resident or distributed in the operating system 1108, a program 1112, or implemented with special purpose memory and processors. Computer 1102 may also implement a compiler 1114 that allows a program (e.g., code) 1112 written in a programming language to be translated into processor 1104 readable code. After completion, program 1112 may access and manipulate data stored in memory 1106 of computer 1102 using the relationships and logic that are generated using compiler 1114.

Further, operating system 1108 and program 1112 may include instructions that, when read and executed by computer 1102, may cause computer 1102 to perform the steps necessary to implement and/or use various embodiments of the disclosure. Program 1112 and/or operating instructions may also be tangibly embodied in memory 1106 and/or data communications devices, thereby making a computer program product or article of manufacture according to an embodiment of the present disclosure. As such, the term “program” as used herein is intended to encompass a computer program accessible from any computer readable device or media. Program 1112 may exist on an electronic device (e.g., electronic device 113; see FIG. 1), a server (e.g., server 116; see FIG. 1), a mobile unit (e.g., mobile unit 102; see FIG. 1), and/or another device. Furthermore, portions of program 1112 may be distributed such that some of program 1112 may be included on a computer readable media within an electronic device (e.g., electronic device 113), some of program 1112 may be included on a computer readable media on a server (e.g., server 116), some of program 1112 may be included on a computer readable media on a surveillance unit (e.g., unit 102), and/or some of program 1112 may be included on a computer readable media on another device. In some embodiments, program 1112 may be configured to run on electronic device 113, server 116, unit 102, another computing device, or any combination thereof. As a specific example, program 1112 may exist on server 116 and/or unit 102 and may be accessible to a user via electronic device 113.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed is:

1. A system, comprising:
a device including a controller having an operating system installed thereon; and
a cloud server communicatively coupled to the device via a cellular communication network;
wherein the device is configured to:
request an updated operating system; and
receive, sequentially, a number of portions of an image of the updated operating system from the cloud server via the cellular communication network.

2. The system of claim 1, wherein the cloud server is configured to receive the image of the updated operating system from an image generation pipeline.

3. The system of claim 1, further comprising a mobile surveillance unit including the device.

4. The system of claim 1, wherein the device is further configured to install each portion of the number of portions on a hard drive of the controller.

5. The system of claim 1, wherein the device is further configured to install a bootloader on the controller prior to receiving the number of portions of the image of the updated operating system, wherein the bootloader includes an operating system updater program.

6. The system of claim 1, further comprising an application programming interface (API) communicatively coupled to the controller and configured to receive the image of the updated operating system from an image generation pipeline.

7. A method of updating an operating system of a mobile unit, comprising:
booting an operating system of a controller of a mobile unit;
downloading, individually and via a cellular communication network, a plurality of portions of an image of updated operating system to the controller; and
installing each portion of the plurality of portions on a hard drive of the controller.

8. The method of claim 7, further comprising installing a bootloader on the controller after booting the operating system.

9. The method of claim 7, wherein downloading comprises downloading the plurality of portions from a cloud server.

10. The method of claim 7, further comprising determining if the operating system should be updated based on a comparison of an assigned operating system image for the controller and a current operating system image for the controller.

11. The method of claim 10, wherein the downloading the plurality of portions of the image of the updated operating system comprises downloading, in response the determining that the operating system should be updated, the plurality of portions of the image of the updated operating system.

12. The method of claim 7, further comprising creating a number of partitions and a file system on the hard drive prior to installing.

13. The method of claim 12, wherein downloading comprises downloading a number of compressed tarball chunks, wherein installing comprises unpacking the downloaded compressed tarball chunks into the file system.

14. The method of claim 7, wherein installing comprises unpacking each portion of the downloaded plurality of portions into an associated file system.

15. The method of claim 7, further comprising launching an operating system updater program after booting the operating system and prior to downloading the plurality of portions.

16. A system, comprising:
a server; and
a number of mobile surveillance units, each mobile surveillance unit of the number comprising:
a trailer;
a mast coupled to the trailer; and
a head unit coupled to the mast and comprising a controller having an operating system stored thereon, the controller communicatively coupled to the server via a cellular communication network;
wherein the controller is configured to:
boot the operating system;
receive, from the server, a plurality of portions of an updated operating system image; and
install each portion of the plurality of portions on a hard drive of the controller.

17. The system of claim 16, further comprising an application programming interface (API) communicatively coupled to the controller and configured to receive the updated operating system image from an image generation pipeline.

18. The system of claim 17, wherein the controller is configured to receive, from the API, information regarding the updated operating system image prior to receipt of the plurality of portions of the updated operating system image.

19. The system of claim 16, wherein the controller is further configured to:
receive one or more bootloader files; and
execute at least one bootloader file of the one or more bootloader files to install a bootloader to enable an updated operating system to be installed on the controller.

20. The system of claim 16, wherein the controller is configured to receive the plurality of portions sequentially, one at a time.

21. The system of claim 16, further comprising an image generation pipeline configured to convey the updated operating system image to the server.

22. A system, comprising:
a mobile surveillance unit including a controller with an operating system installed thereon; and
a device remote from the mobile surveillance unit and communicatively coupled to the controller via a cellular communication network, the device configured to convey at least one bootloader file to the controller;
wherein the controller is configured to execute the at least one bootloader file to install a bootloader to enable an updated operating system to be installed on the controller.

23. The system of claim 22, wherein the at least one bootloader file comprises an environment image and an application to install the bootloader.

24. The system of claim 23, wherein, after installation of the bootloader and the updated operating system, the controller includes:
the bootloader including a boot partition, a root partition, and a settings partition; and
the updated operating system including a boot partition and a root partition.

25. The system of claim 24, wherein, prior to installation of the bootloader, the controller includes:
a boot partition;
a system read only partition;
a system read write partition; and
at least one data partition.

26. The system of claim 25, wherein, after installation of the bootloader and the updated operating system, the controller includes:
a bootloader boot partition;
a bootloader root partition;
a settings partition; and
an extended partition including a boot partition, a root partition, and a data partition.

27. A method of updating an operating system of a mobile device, the method comprising:
conveying, via a cellular communication network, one or more bootloader files to a controller of the mobile device;
executing at least one bootloader file of the one or more bootloader files to install a bootloader on the controller of the mobile device;
receiving, at the mobile device and via a cellular communication network, a plurality of portions of an image of an updated operating system; and
installing each portion of the image of the plurality of portions on the controller.

28. The method of claim 27, wherein receiving the plurality of portions comprises receiving, sequentially, each portion of the image of the plurality of portions of the image of the updated operating system.

29. The method of claim 27, further comprising booting the controller after installing the bootloader and prior to receiving the plurality of portions of the image of the operating system.

30. The method of claim 27, further comprising determining, based on a comparison of an assigned operating system image for the controller and a current operating system image for the controller, that the updated operating system should be installed on the controller.
